(19) United States
(12) Patent Application Publication
(10) Pub. No.: US 2022/0234381 A1
(43) Pub. Date: Jul. 28, 2022

(54) WRITING IMPLEMENT HOLDING ERASER

(71) Applicant: COMSERO, INC., Thornton, CO (US)

(72) Inventor: Anthony Franco, Thornton, CO (US)

(21) Appl. No.: 17/161,078

(22) Filed: Jan. 28, 2021

(51) Int. Cl. B43L 19/00

(52) U.S. Cl. CPC B43L 19/00; B43L 1/00

(57) ABSTRACT

An eraser includes a body portion defining a plurality of passages configured to hold a plurality of writing implements. The eraser may further include an eraser portion forming a side of the body portion. The eraser may further include an attachment portion forming a second side the body portion. The attachment portion may be configured to releasably secure the eraser to a writable surface formed from a non-magnetic material. An eraser kit may include the eraser and a plurality of writing implements. In a first configuration, the eraser may releasably secured to a writable surface using the attachment portion. In a second configuration, the eraser may be engaged with the writable surface to modify markings using the eraser portion.

### FIELD

The described embodiments relate generally to erasers for various writing surfaces, such as dry erase surfaces.

### BACKGROUND

Erasers may be used to modify or substantially clear markings from a writable surface, e.g., dry erase surfaces, chalkboards, and the like. Erasers can often be misplaced or otherwise become inaccessible when needed, such as when a surface requires clearing during an instructional lesson. Chalk, markers, pens, and other types of writing implements that may be used with the surface are often also misplaced. As such, there is a need for systems and techniques to facilitate eraser and accessory association with a writable surface.

### SUMMARY

In one example, an eraser is disclosed. The eraser includes a body portion defining a plurality of passages configured to hold a plurality of writing implements. The eraser further include an eraser portion forming a side of the body portion.

An another example, an eraser is disclosed. The eraser includes a body portion configured to hold a writing implement. The eraser further includes an eraser portion forming a first side of the body portion. The eraser further includes an attachment portion forming a second side the body portion. The attachment portion may be configured to releasably secure the eraser to a writable surface.

In another example, an eraser kit is disclosed. The eraser kit includes a plurality of writing implements. The eraser kit further includes an eraser coupleable with the plurality of writing implements and including an attachment portion and an eraser portion. In a first configuration, the eraser is releasably secured to a writable surface using the attachment portion. In a second configuration, the eraser is engaged with the writable surface to modify markings using the eraser portion.

### BRIEF DESCRIPTION OF THE DRAWINGS

FIG. 1 depicts an eraser kit releasably secured to a writable surface.

FIG. 2 depicts an exploded view of the eraser kit of FIG. 1.

FIG. 3 depicts a front elevation view of an eraser of the eraser kit of FIG. 2.

FIG. 4 depicts a rear elevation view of the eraser of FIG. 2.

FIG. 5 depicts a left side elevation view of the eraser of FIG. 2.

FIG. 6 depicts a top plan view of the eraser of FIG. 2.

FIG. 7 depicts a bottom plan view of the eraser of FIG. 2.

FIG. 8 depicts a cross-sectional view of the eraser and writable surface of FIG. 1, taken along line 8-8 of FIG. 1.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates to erasers configured to hold one or more writing implements. The erasers may be releasably securable to a writable surface, where the attachment mechanism may be varied to be couplable to various types surfaces, including those with magnetic elements, non-magnetic elements, and so on. An example eraser may include a body portion having a plurality of passages or other storage features configured to hold a plurality of writing implements. The writing implements may be restrained from moving within the body potion, e.g., the passages may be selected to have a diameter and/or shape that allows the implements to be secured in place while the eraser moves, but also to be easily removable by a user. Additionally, a writing implement may be selectively removable from the body portion without disturbing other writing implements held by the eraser.

The eraser may be configured to hold the writing implement while the eraser is releasably secured to the writable surface, which may be a vertically oriented surface. The writable surface, without limitation, may include a dry erase board, a chalkboard, a mirror, a glass surface, a metal surface, and so on. The eraser may include an attachment portion that forms a side, surface, and/portion of the body portion. The attachment portion may include a micro-suction foam, magnet, loop and hook, or other attachment mechanism configured to permit the releasable securement of the eraser to the writable surface. In some cases, the attachment portion may exert an attraction force sufficient to temporarily mount the eraser to the vertically oriented surface and maintain a position of the vertically oriented surface while the eraser holds the plurality of writing implements. The attachment portion may permit the temporary mounting of the eraser on the writable surface, allowing the eraser to be removed and repositioned and mounted on the surface as needed.

The eraser may also include an eraser portion forming another side, surface, and/or portion of the body portion and configured to modify marking on the vertically oriented surface. The eraser portion may be a felt, a foam, a rubber, or other material operable to brush or otherwise physically disrupt the markings from the writable surface. The eraser portion and the attachment portions may form different sides of the body portion. This allows the eraser portion to be separated from the writable surface when the eraser is mounted to the writable surface via the attachment portion and vice versa.

An eraser kit disclosed here may include the eraser and one or more writing implements. The writing elements may extend partially or fully through the body portion with opposing ends of individual writing elements arranged outside the body portion, which may allow a user to more easily grasp and remove the writing implements as desired. The writing implements may be held by the eraser and define a writing implement arrangement, such as the plurality of writing implements having a desired height, sequence, and so on relative to the body portion. As one example, the passages of the eraser body may be narrowed or tapered along a length of the passage to define a predetermined height of the writing implement relative to the body portion. In turn, the body portion may be configured to maintain the writing implements in the writing implement configuration during mounting to the writable surface with the attachment portion and erasure of the writable surface with the eraser portion, and/or while transitioning between the mounting and erasure.

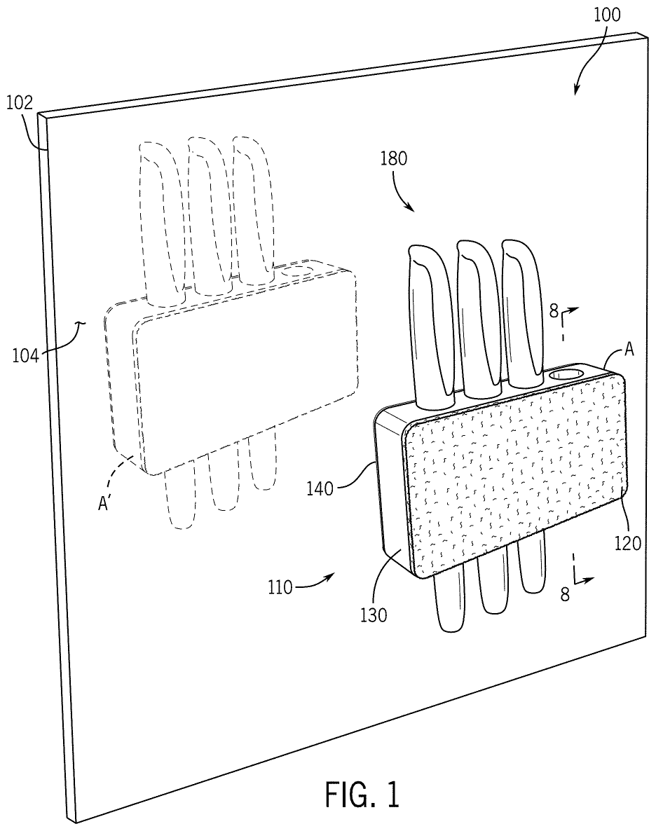

Turning to the drawings, FIG. 1 depicts an eraser kit 100 that includes an eraser 110 and one or more writing implements 180. The eraser 110 is configured to hold the writing implements 180. The writing implements 180 are shown in FIG. 1 as dry erase markers for purposes of illustration, but may also include chalk, pens, pencils, brushes, and other writing implements of various types, shapes, and sizes, without limitation, and may be varied depending on the type of writing surface used.

The eraser is shown associated with a writable surface 102. The writable surface 102 may include a variety of magnetic and non-magnetic surfaces, including a dry erase board, a chalkboard, a mirror, a glass surface, a metal surface, and so on. The writable surface 102 may have a smooth surface 104 which may maximize an surface area of the writable surface 102 that is capable of contact with the eraser 110. The writable surface 102 may define a substantially vertically oriented surface, e.g., the writable surface 102 may be mounted on a wall, but in other configurations, the writable surface 102 may be positioned in other configurations and/or not mounted on a wall or other surface.

The eraser 110 may be configured for removable attachment with the writable surface 102. For example, the eraser 110 may be releasably secured to the writable surface at a first position A, as shown in FIG. 1. The eraser 110 may be configured to maintain the position A relative to the writable surface 102 while holding the plurality of writing implements 180 (i.e., the securing mechanism can support both the weight of the eraser and the writing implements). For example, the eraser 110 may be configured to maintain the position A on a vertically oriented surface while holding each of the plurality of writing implements 180 without substantially sliding, moving, falling or otherwise being displaced from the writable surface 102. The eraser 110 may be removed from the writable surface 102 position A, and subsequently mounted to the writable surface 102 at a second position A′ (shown in phantom line). The eraser 110 may be configured to maintain the position A′ relative to the writable surface 102 while holding the plurality of writing implements 180.

The eraser 110 is also adapted to modify or remove markings from the writable surface 102. For example, the eraser 110 is shown in FIG. 1 with an eraser portion 120. The eraser portion 120 may include a felt, a foam, a rubber, or other material that operates to brush or otherwise physically disrupt the markings from the writable surface 102. The eraser 110 may be selectively removed from the writable surface 102 and manipulated, including being flipped or rotated, such that the eraser portion 120 engages the writable surface 102. The eraser 110 is configured to maintain an arrangement or orientation of the plurality of writing implements during the mounting and/or moving of the eraser 110 on the writable surface 102 and the manipulation of eraser 110 for erasure of the writable surface 102 with the eraser portion 120.

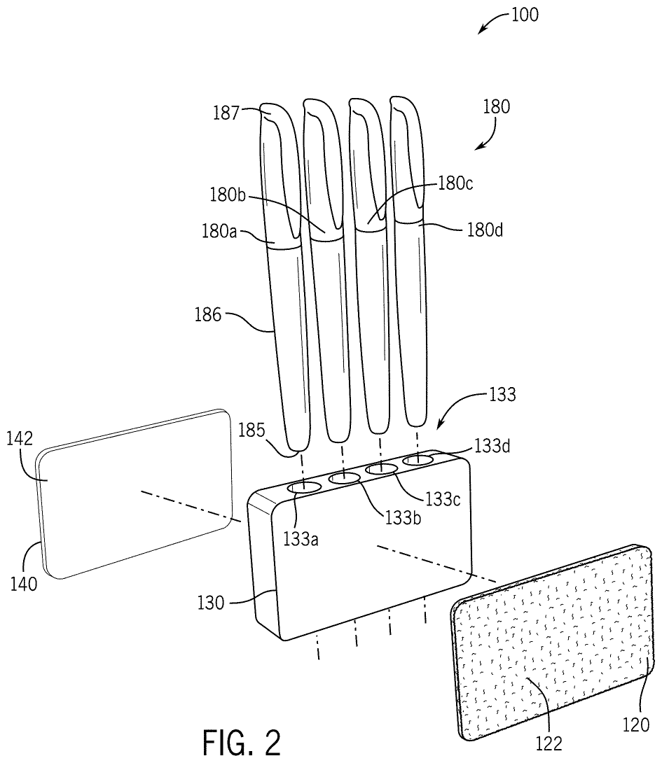

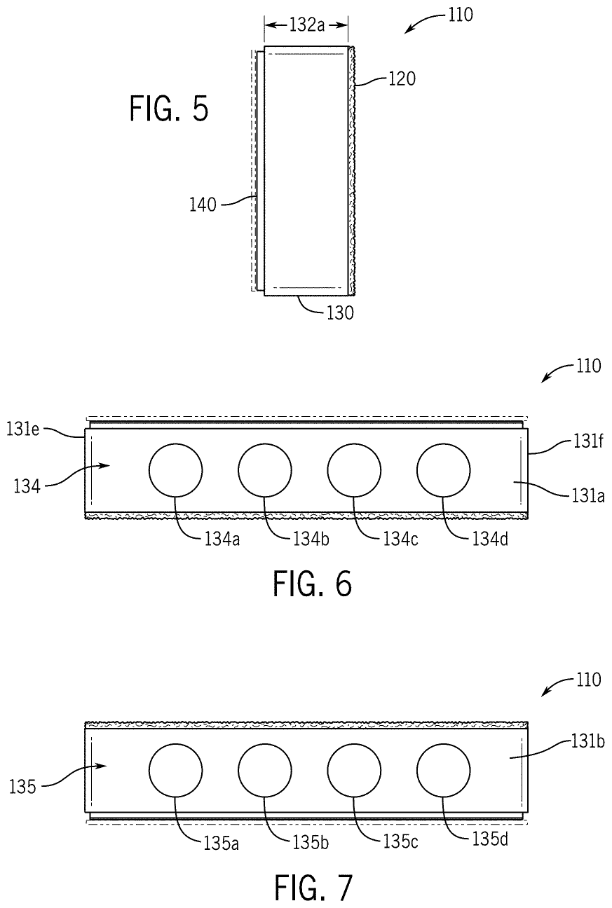

With reference to the exploded view of FIG. 2, the eraser 110 includes the eraser portion 120, a body portion 130, and an attachment portion 140. The body portion 130 may be formed partially or fully from a foam, a plastic, or other natural or synthetic material. The body portion 130 may be a block of material, including a block of material that is formed as a one-piece structure. In other cases, the body portion 130 may be a composite structure. The body portion 130 is shown in FIGS. 2-7 as a hexahedron with six faces. Other three-dimensional structures may be used. In the illustrated example, the body portion 130 includes a first face 131a, a second face 131b, a third face 131c, a fourth face 131d, a fifth face 131e, and a sixth face 131f. The faces 131a-131f may cooperate to define the body portion 130 as a rectangular cuboid. In this regard, the body portion 130 may have a body height 132a, a body width 132b, and a body length 132c, as illustrated in FIGS. 4 and 5. One or more of the body height 132a, the body width 132b, and/or the body length 132b may be configured to define a sufficient spacing between different sides of the eraser 110 in order to separate the eraser portion 120 and the attachment portion 140 by a desired amount. In the illustrated, the body height 132a may be less than a body width 132b, and the body width 132b may be less than the body length 132c. Other relative dimensions are contemplated herein.

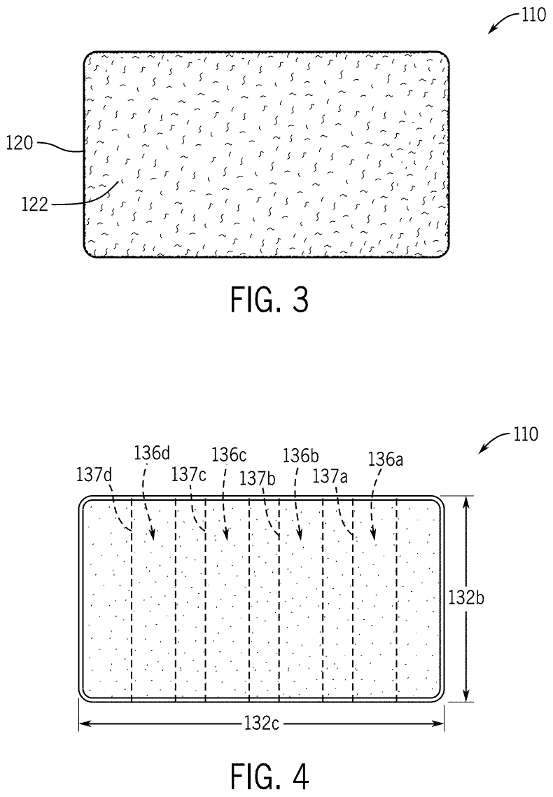

The body portion 130 may define one or more passages 133. In the example shown in FIGS. 3 and 4, the passages 133 may include a first passage 133a, a second passage 133b, a third passage 133c, and a fourth passages 133d. In other example, more or fewer passages may be defined by the body portion 130, such as examples with five or six or passages, and/or examples with three, or two, or a single passage. The passages 133 may extend completely through the body portion 130, e.g., extending between opposing surfaces or faces 131a and 131b and through a length or width of the body portion 130. For example and as shown in FIG. 6, the body portion 130 may define a plurality of openings 134 on the first face 131a, such as a first opening 134a, a second opening 134b, a third opening 134c, and a fourth opening 134d. Further and as shown in FIG. 7, the body portion 130 may further define a plurality of openings 135 on the second face 131b, such as a such as a first opening 135a, a second opening 135b, a third opening 135c, and a fourth opening 135d. The first passage 133a may extend through the body portion 130 between the first opening 134a and the first opening 135a, the second passage 133b may extend through the body portion 130 between the second opening 134b and the second opening 135b, the third passage 133c may extend through the body portion 130 between the third opening 134c and the third opening 135c, and the fourth passages may extend through the body portion 130 between the fourth opening 134d and the fourth opening 135d.

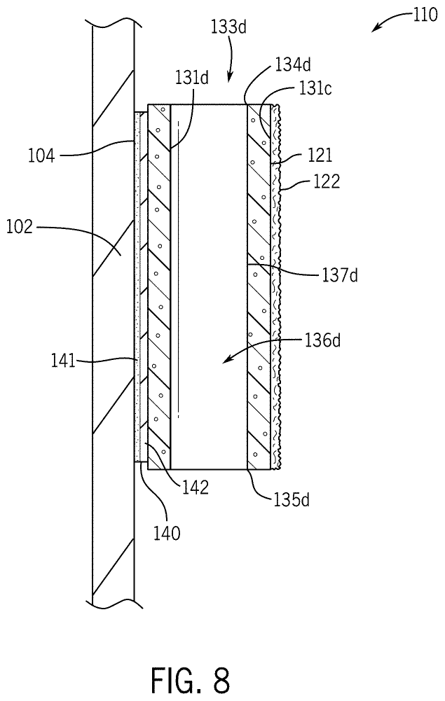

The passages 133 may define interior channels 136 extending through an entire height, width, or length of body portion 130, such as entirely through the body width 132b, as shown in FIG. 4. Continuing with the non-limiting example of the eraser 110 being configured to hold four writing implements, a first interior channel 136a, a second interior channel 136b, a third interior channel 136c, and a fourth interior channel 136d is shown in FIG. 4. The body portion 130 may define implement engagement surface 137 within the interior channels 136. The implement engagement surface 137 may be substantially cylindrical interior surfaces of the body portion 130, as shown in FIGS. 4 and 8, with the illustrated first implement engagement surface 137a, a second of implement engagement surface 137b, a third implement engagement surface 137c, and a fourth implement engagement surface 137d. The cylindrical interior surfaces of illustrated body portion 130 may generally have a consistent thickness or diameter along a length of the cylindrical tubes.

In some cases, the implement engagement surface 137 may include a taper or otherwise be varied in size or shape along their length. In some cases, the implement engagement surface 137 may include or at least partially define a storage feature that is imbedded in the eraser body 130 to engage a writing implement within the body. Additionally or alternatively, the implement engagement surface 137 may be at least partially compressible or deformable, such as being partially compressible or deformable upon engagement with a writing implement. For example, the eraser body portion 130 may be formed partially or fully from flexible foam. In this regard, the implement engagement surface 137 may be a surface of the flexible foam that is sized to define the respective interior channel as having a size that matches or is slightly less than a size of a target one of the plurality of writing implement 180. The flexible foam may exert a retaining force on the writing implement when the writing implement is received within the interior channel. The retaining force may be overcome by sliding or otherwise selectively removing the writing implement from the eraser body 130. This may allow the implement engagement surface 137 to retain the writing implement using a friction or interference fit.

With reference to FIGS. 2 and 8, the eraser portion 120 may be a layer or substrate having an eraser attachment side 121 and an erasure side 122. The eraser attachment side 121 and the erasure side 122 may be opposing sides of the eraser portion 120. The attachment side 121 may include or be associated with an adhesive, although this is not required. The erasure side 122 may include a rough texture 123, including microfiber, felt, or brush elements that operate to engage the writable surface 102 and disrupt markings. In other cases, the erasure side 122 may be formed integrally with the body portion 130.

The attachment portion 140 may include, or be formed partially or full from substantially any material that is configured to releasably secure the eraser to a writable surface. As one example, the attachment portion 140 may exert an attraction force sufficient to temporarily mount the eraser 110 to the writable surface 102. The attraction force may retain the eraser 110 and the plurality of writing implements 180 mounted to the writable surface 102 in the substantially vertical orientation. For example, the attraction force may be sufficient to retain the eraser 110 and the plurality of writing implements 180 on a surface that is oriented substantially perpendicularly to a grade or other elevationally level surface. In some cases, the attachment portion 140 may be formed at least partially from a micro-suction foam that generates a suction force. Additionally or alternatively, the attachment portion 140 may include an embedded magnetic material that generates a magnetic force. Additionally or alternatively, the attachment portion 140 may be formed partially or fully from other materials broadly configured to generate an attraction force, including but not limited to, tacky materials, adhesive, hook and loop, fasteners, or the like, where the attachment allows the eraser to be attached and detached multiple times, i.e., is not single use. In this regard, the attachment portion 140 may interact or couple with a complementary attachment feature of the writable surface 102, including a complementary magnetic feature, hook feature, fastener feature, and so on.

With reference to FIGS. 2 and 8, the attachment portion 140 may be a layer or substrate having an writable surface attachment side 141 and an eraser attachment side 142. The writable surface attachment side 141 and the eraser attachment side 142 may be opposing sides of the attachment portion 140. The eraser attachment side 142 may include or be associated with an adhesive or other feature to create a substantially permanent bond between the attachment portion 140 and the body portion 130. The writable surface attachment side 141 may be fully or partially defined by the material configured to exert the attraction force, such as the suction foam. Additionally or alternatively, the writable surface attachment side 141 may include a cover layer that defines a barrier material the material configured to exert the attraction force and the writable surface 102, as may be the case where the material is magnet. Prior to use, a release layer may be arranged over the attachment portion 140, such as a wrapping, a film, a consumable layer, or the like. The release layer be configured to preserve or maintain the attraction force prior to use.

The eraser 110 may be coupled such that the eraser portion 120 and the attachment portion 140 are secured to the body portion 130. The eraser portion 120 may be secured to body portion 130 such that the eraser portion 120 is separated from the writable surface 102 when the eraser 110 is mounted to writable surface 102 via the attachment portion 140. Additionally, the attachment portion 140 may be secured to the body portion 130 such that the attachment portion 140 is separated from the writable surface 102 when the eraser is engaging the writable surface 102 with the eraser portion 120.

For example and as shown with reference to FIGS. 2 and 3, the eraser portion 120 may by secured to the third face 131c of the body portion 130 and the attachment portion 140 may be secured to the fourth face 131d of the body portion 130. In this regard, the eraser portion 120 may be coupled to a first region of the body portion 130 and the attachment portion 140 may be coupled to a second region of the body portion that are opposing regions or surfaces of the body portion 130. It will be appreciated, however, that in other examples, that eraser portion 120 and the attachment portion 140 may have other relationship, such as being arranged substantially perpendicular to one another or otherwise arranged relative to one another at a non-zero angle.

For example and as shown in FIGS. 3 and 4, the eraser attachment side 121 of the eraser portion 120 may be adhered to the third face 131c of the body portion 130. Further, the eraser attachment side 142 of the attachment portion may be adhered to the fourth face 131d of the body portion 130. While the present illustrated example may user certain glues and adhesives, fasteners, clips, hooks, and the like may also be used to secure the eraser portion 120 and the attachment portion 140 to the body portion 130. In some cases, the eraser portion 120 and/or the attachment portion 140 may be removably secured to the body portion 130, which may be desirable to change the easer material after a period of use.

In addition to the various functional considerations, the shape and the appearance of the eraser 110 may be selected to have an aesthetically pleasing appearance. For example, the passages 133 may be selected to have a size, shape and arrangement relative to the eraser body portion 130 to enhance the aesthetic appearance of the eraser 110. Additionally or alternatively, the body height 132a, the body width 132b, and/or a body length 132c may be defined relative to one another to enhance the aesthetic appearance of the eraser 110. In other cases, other features may be configured to enhance the aesthetic appearance of the eraser 110.

The eraser portion 120 and the attachment portion 140 may be coupled to the body portion 130 such that one or both of the eraser portion 120 or the attachment portion 140 is inset from a footprint or outer perimeter of the body portion 130. For example and with reference to FIG. 4, the attachment portion 140 is shown coupled to the body portion 130. The writable surface attachment side 141 may have a smaller overall surface area than the fourth face 131d. As shown in FIG. 4, the attachment portion 140 is centered on the fourth face 131d with the writable surface attachment side 141 inset from the perimeter defined by the fourth face 131d. In other cases, the attachment portion 140 may be coupled off center with one or more all of the edges of the attachment portion 140 aligned with the perimeter of the fourth face 131d.

In operation, the eraser 110 is coupleable with the plurality of writing implements 180 in an eraser kit 100. The passages 133 may be configured to receive the plurality of writing implements 180 and hold the plurality of writing implements 180 in the eraser 110, such as the first passage 133a receiving a first writing implement 180a, the second passage 133b receiving a second writing implement 180b, the third passage 133c receiving a third writing implement 180c, the fourth passage 133d receiving a fourth writing implement 180d, and so on an appropriate based on the number of writing implements.

For purposes of illustration, the operation of the first passage 133a and the first writing implement 181a is described below. It will be appreciated that the passages 133b-133d and writing implements 181b-181d may be substantially similar. The first writing implement 181a may be received by the first passage 133a and inserted fully through the first interior channel 136a. For example, a first end 185 of the first writing implement 181a may be inserted through the first opening 134a, passed or slid through the first interior channel 136a, and through the first opening 135a. A middle 186 of the first writing implement 181a may remain within the body portion 130. The middle 186 may remain within the first interior channel 136a such that the body portion 130 completely surrounds or encircles the middle 186. The first implement engagement surface 137a may contact or engage the middle 186. In some cases, the first implement engagement surface 137 may compress or otherwise exert a force on the middle 186 in order to restrain movement of the first writing implement 181a. The first writing implement 181a may include a second end 187 opposite the first end 186. The first and second ends 185, 187 may be positioned away from the body portion 130 with the middle 186 surrounded by the body portion 130.

With reference to the cross-sectional view of FIG. 8, the eraser kit 100 operates with the eraser 110 mounted on the writable surface 102. For example, the attachment portion 140 may be engaged with the writable surface 102. The attachment portion 140 is shown in FIG. 8 as exerting a sufficient force to maintain a mounting of the eraser 110 and the plurality of writing implements 180 mounted to the writable surface 102. The eraser 110 may be moved, slid, removed and replaced on the writable surface 102, with the attachment portion 140 further operating to mount the eraser kit 100 to the writable surface 102. For example, a user may engage the eraser 110 and separate the eraser 110 from the writable surface 102 by overcoming the attraction force the attachment portion 120. The eraser 110 may be decoupled from the writable surface 102 and manipulated in order to engage the eraser portion 120 with the writable surface 102 and modify markings on the writable surface 102. The user may further manipulate the eraser 110 and releasably couple the eraser 110 to the writable surface 102 again using the attachment portion 120. The user may releasably couple the eraser 110 at the same or a different position, allowing for flexibility in placement of the eraser 110 across the writable surface 102.

In operation, the eraser kit 100 may be manipulateable between a first configuration in which the eraser kit 100 is mounted to the writable surface 102 and a second configuration in which the eraser kit 100 is engaged with the writable surface 102 to modify markings on the writable surface 102. The plurality of writing implements 180 may have or define a writing implement orientation in the eraser 110, such as being arranged having a certain height, sequence, spacing and/or other characteristic. The writing implement orientation may be maintained in the first and second configurations, and manipulations therebetween. Any of the plurality of writing implement may be selectively removed from the eraser 110, such as being removing for marking the writable surface 102. The writing implement can be returned to the eraser 110 accordingly. The remaining writing implements, e.g., writing implements not removed, may remain substantially undisturbed during the selective removal and replacement of the desired writing implement.

Other examples and implementations are within the scope and spirit of the disclosure and appended claims. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. An eraser comprising:
a body portion defining a plurality of passages configured to hold a plurality of writing implements; and
an eraser portion forming a side of the body portion.

2. The eraser of claim 1, wherein the plurality of passages extend through an entire width of the body portion.

3. The eraser of claim 1, wherein the body portion is configured to restrain movement of writing implements.

4. The eraser of claim 3, wherein the plurality of passages are defined through the body portion by interior cylindrical surfaces.

5. The eraser of claim 1, further comprising an attachment portion forming another side of the body portion and configured to releasably secure the eraser to a writable surface.

6. The eraser of claim 5, wherein the attachment portion is configured to exert an attraction force to mount the eraser to the writable surface.

7. The eraser of claim 6, wherein the attachment portion comprises a micro-suction foam.

8. The eraser of claim 5, wherein the eraser portion and the attachment portion are arranged such that the eraser portion is separated from the writable surface when the eraser is mounted to the writable surface via the attachment portion.

9. An eraser comprising:
a body portion configured to hold a writing implement;
an eraser portion forming a first side of the body portion; and
an attachment portion forming a second side the body portion, wherein the attachment portion is configured to releasably secure the eraser to a writable surface formed from a non-magnetic material.

10. The eraser of claim 9, wherein the attachment portion is further configured to releasably secure the eraser to another writable surface formed from a magnetic material.

11. The eraser of claim 9, wherein the attachment portion is further is configured to exert an attraction force to mount the eraser to a vertically oriented surface, and wherein the attraction force is configured to maintain a mounting of the eraser to the vertically oriented surface.

12. The eraser of claim 9, wherein the body portion is configured to engage a middle portion of the writing implements such that opposing ends of the writing implement are arranged outside of the body portion.

13. The eraser of claim 9, wherein the body portion is configured to hold the writing implement such that a least a portion of the writing implements is surrounded by the body portion.

14. The eraser of claim 9, wherein the body portion is configured to define a friction fit or an interference fit with the writing implement.

15. The eraser of claim 9, wherein
in a first configuration, the eraser is mounted to a vertically oriented surface,
in a second configuration, the eraser is engaged with the vertically oriented surface,
the body portion is configured to hold a plurality of writing implements in a writing implement arrangement, and
the body portion is configured to maintain the plurality writing implements in the writing implement arrangement in the first configuration and the second configuration.

16. An eraser kit comprising:
at least one writing implement; and
an eraser coupleable with the of the at least one writing implement and comprising an attachment portion and an eraser portion,
wherein
in a first configuration, the eraser is releasably secured to a writable surface using the attachment portion, and
in a second configuration, the eraser is engaged with the writable surface to modify markings using the eraser portion.

17. The kit of claim 16, wherein writing implements of the plurality of writing implements are individually releasable from, and replaceable into, the eraser.

18. The kit of claim 16, wherein the attachment portion is configured to release secure the eraser to both a non-magnetic material and a magnetic material.

19. The kit of claim 16, wherein the eraser is couplable with the plurality of writing implements to extend the plurality of writing implements fully through a body portion of the eraser.

20. The kit of claim 16, wherein one or both of the eraser portion or the attachment portion are inset from an outermost perimeter of the eraser.
